(19) United States
(12) Patent Application Publication
(10) Pub. No.: US 2014/0287094 A1
(43) Pub. Date: Sep. 25, 2014

(54) Dough Composition for Sugarless Bread Sugarless Bread and Processes for Making Them

(71) Applicant: Paris Croissant Co., Ltd., Gyeonggi-do (KR)

(72) Inventors: Chung Kil Park, Seoul (KR); Cheon Yong Lee, Gyeonggi-do (KR); Shin Hak Oh, Gyeonggi-do (KR); Jong Hyuk Lee, Gyeonggi-do (KR); Byeong Cheol Kim, Seoul (KR)

(73) Assignee: Paris Croissant Co., Ltd., Gyeonggi-do (KR)

(21) Appl. No.: 14/199,842

(22) Filed: Mar. 6, 2014

(30) Foreign Application Priority Data
Mar. 25, 2013 (KR) 10-2013-0031423

(51) Int. Cl. A21D 8/04; A21D 13/04; A21D 10/00

(52) U.S. Cl. CPC A21D 8/047; A21D 10/005; A21D 13/04
USPC 426/10; 426/62; 426/549; 426/18; 426/558

(57) ABSTRACT

Provided are a dough composition for sugarless bread, sugarless bread and a processes for making them, which can reduce sugar content in baking bread without sugar added, thereby lowering the intake of sugar, which may cause diseases such as diabetes or obesity. The dough composition for sugarless bread includes (A) 0.1 to 1.1 parts by weight of an improver, (B) 15 to 50 parts by weight of a grain mixture, and (C) 1.0 to 2.5 parts by weight of yeast, based on 100 parts by weight of flour of the dough composition. The present invention can provide sugarless bread with low sugar content by suppressing sugar from being generated during the baking process. Since the sugarless bread according to the present invention lowers the intake of sugar, which may cause diseases such as diabetes or obesity.

### CROSS-REFERENCE TO RELATED APPLICATION

This application claims priority to and the benefit of Korean Patent Application No. 10-2013-0031423, filed on Mar. 25, 2013, the entire content of which is incorporated herein by reference.

### BACKGROUND OF THE INVENTION

1. Field of the Invention

Aspects of the present invention relate to a dough composition for sugarless bread, sugarless bread and processes for making them.

2. Description of the Related Art

Nowadays, in people's diversified dietary life styles, excessive intake of glucide, such as sugar or fructose, may bring about obesity and may increase the risk of adult diseases, such as diabetes or cardiac disorders. Due to gradual westernization of dietary habits, bread is rapidly becoming principle food of Koreans in addition to rice, and consumption of bread is gradually increasing.

Bread is generally made by mixing wheat flour, water, salt, yeast, etc., as main ingredients, and sugar, dairy products, oil, etc., as secondary ingredients may further be added to increase taste and texture of bread. In practice, a considerable amount of sugar may be ingested through bread.

In making bread, sugar functions as a sweetener but plays an important role as a fermentation controller. During fermentation of bread dough, glucide is decomposed by yeast and causes expansion of the dough. However, if sugar is not added in making bread, fermentation of bread dough may be delayed and fermentation capacity may be lowered. If the fermentation capacity is not sufficient, softness of a bread product may not be ensured and aging of the bread product may be expedited. Since sugar as a supplying source of yeast is not added at all, carbonate gas generated by fermentation is stuck in a reticular gluten film in the dough, thereby preventing the dough from expanding. Therefore, if no sugar is added, the bread may have a small volume and the intra-phase of crumb is considerably compact, resulting in poor textural qualities. In addition, if no sugar is added, caramelization is not carried out in baking the bread, thereby making the bread product colored in brown. In addition, byproducts resulting from the baking may significantly affect the flavor of the product, which is because browning of sugar and carbohydrate may not be carried out due to heat. Accordingly, the present invention has been proposed to provide sugarless bread, which can suppress adverse effects exerted by the excessive intake of sugar while improving the taste and textural quality of bread.

### BRIEF SUMMARY OF THE INVENTION

Aspects of the present invention provide a dough composition for sugarless bread, which can prevent fermentation capacity of yeast from lowering by adding no sugar and can control sugar content while making bread.

Other aspects of the present invention provide sugarless bread made using the dough composition for sugarless bread.

Aspects of the present invention further provide a process for making the sugarless bread.

In accordance with one aspect of the present invention, there is provided a dough composition for sugarless bread, including (A) 0.1 to 1.1 parts by weight of an improver, (B) 15 to 50 parts by weight of a grain mixture, and (C) 1.0 to 2.5 parts by weight of yeast, based on 100 parts by weight of flour of the dough composition, wherein the grain mixture includes one or more selected from the group consisting of alpha soybean powder, eggs, soy protein isolate and gluten. The improver (A) may include one or more selected from the group consisting of hemicellulase, vitamin C, seaweed calcium, emulsifier, and glucoseoxidase.

The grain mixture may include one or more selected from the group consisting of rice powder, barley powder and brown rice powder.

Based on 100 parts by weight of flour of the dough composition, the grain mixture may include 3 to 15 parts by weight of barley powder, 3 to 15 parts by weight of brown rice powder, 0 to 5 parts by weight of alpha soybean powder, 10 to 40 parts by weight of eggs, 0 to 5 parts by weight of soy protein isolate, and 0 to 3 parts by weight of gluten.

In accordance with another aspect of the present invention, there is provided sugarless bread made from the dough composition.

In accordance with still another aspect of the present invention, there is provided a processes for making sugarless bread, the process including preparing a first dough composition to mix ingredients of the first dough composition, first fermentation of preparing a first fermentation product by fermenting the first dough composition, preparing a second dough composition to mix the first fermentation product and ingredients of the second dough composition, and second fermentation of preparing a second fermentation product by fermenting the second dough composition, and baking the second fermentation product, wherein the first dough composition includes (A) 0.1 to 1.1 parts by weight of an improver, and (B) 0.5 to 0.8 parts by weight of yeast, based on 100 parts by weight of flour, the second dough composition including (A) 0.1 to 1.1 parts by weight of an improver, (B) 15 to 50 parts by weight of a grain mixture, and (C) 1.0 to 2.5 parts by weight of yeast, based on 100 parts by weight of flour, and the grain mixture may include one or more selected from the group consisting of alpha soybean powder, eggs, soy protein isolate and gluten.

As described above, according to the present invention, the dough composition for sugarless bread can shorten a fermentation time of dough and can prevent fermentation capacity of dough from lowering without adding sugar to the dough composition. In addition, the dough composition for sugarless bread according to the present invention can control sugar content in making bread. Further, the present invention can provide sugarless bread with low sugar content by suppressing sugar from being generated during the baking process by changing a proportion of flour in sponge dough and dough processes. Since the sugarless bread according to the present invention lowers the intake of sugar, which may cause diseases such as diabetes or obesity, thereby achieving health promotion and disease prevention.

Additional aspects and/or advantages of the invention will be set forth in part in the description which follows and, in part, will be obvious from the description, or may be learned by practice of the invention.

### DETAILED DESCRIPTION OF THE INVENTION

Hereinafter, embodiments of the present invention will be described in detail.

The present invention provides a dough composition for sugarless bread. The dough composition for sugarless bread is a dough composition for making bread without adding sugar. In addition, during fermentation, it is controlled for the yeast to use only the sugar contained in flour and other grain ingredients, thereby preventing fermentation capacity from lowering and a fermentation time from being prolonged. Further, the present invention can provide sugarless bread with low sugar content by employing ingredients with low content and controlling the content of the remaining sugar which may be generated in making the bread.

In the present invention, the term “sugarless” used herein may mean that sugar is not added at all in view of food labeling standards of Ministry of Food and Drug Safety, and a total sugar balance of less than 0.5g/100g in consideration of the sugar that may be generated during the process.

The dough composition for sugarless bread according to the present invention may include flour as a main ingredient and may additionally include (A) improver, (B) yeast, and (C) grain mixture. In addition, the dough composition for sugarless bread may further include (D) additives that can be employed to making sugarless bread.

(A) Improver

The improver controls amounts of enzymes remaining in flour or grains in making bread or sugar naturally generated in fermentation and baking processes and lowers the fermentation capacity of yeast due to non-addition of sugar. The improver may be contained in an amount of 0.1 to 1.1 by weight, based on 100 parts by weight of flour of the dough composition. If the content of the improver is less than 0.1 parts by weight, the size and quality of bread may be deteriorate and the bread may have coarse textural quality. If the content of the improver is greater than 1.1 parts by weight, it may be difficult to control the sugar content during the process. The improver may include one or more selected from the group consisting of hemicellulase, glucoseoxidase, vitamin C, seaweed calcium, and emulsifier. Preferably, the improver may include 0.0005 to 0.002 parts by weight of hemicellulase, 0.002 to 0.008 parts by weight of glucoseoxidase, 0.0015 to 0.004 parts by weight of vitamin C, 0.01 to 0.02 parts by weight of seaweed calcium, and 0.986 to 1.066 parts by weight of emulsifier, based on 100 parts by weight of flour of the dough composition.

(B) Yeast

The yeast may offer a soft textural quality of bread through fermentation. The yeast may be included in an amount of 1.0 to 2.5 by weight, based on 100 parts by weight of flour of the dough composition. If the content of the yeast is less than 1.0 part by weight, a fermentation time is prolonged, so that the size of bread may be deteriorated and the bread may have a coarse intra-phase. If the content of the yeast is greater than 2.5 parts by weight, the fermentation time may be excessively shortened, so that the sugar content may exceed 0.5g/100g.

(C) Grain Mixture

The grain mixture may lower sugar content of a final product using a source ingredient having smaller sugar content than flour and may increase textural quality of the product. The grain mixture may be included in an amount of 15 to 50 parts by weight, based on 100 parts by weight of flour of the dough composition. If the content of the grain mixture is more than 15 parts by weight, the sugar content of the product may increase to 0.5g/100g or greater. If the content of the grain mixture is less than 50 parts by weight, bread properties may be adversely affected, making it difficult to complete the baking process.

The grain mixture may include one or more selected from the group consisting of rice powder, barley powder and brown rice powder. In addition, the grain mixture may further include one or more selected from the group consisting of alpha soybean powder, eggs, soy protein isolate and gluten. Preferably, the grain mixture may include 3 to 15 parts by weight of barley powder; 3 to 15 parts by weight of brown rice powder; 0 to 5 parts by weight of alpha soybean powder; 10 to 40 parts by weight of eggs; 0 to 5 parts by weight of soy protein isolate; and 0 to 3 parts by weight of gluten, based on 100 parts by weight of flour of the dough composition.

(D) Additives

The additives may be used without limitation as long as they can be suitably applied in making bread, and examples thereof may include salt, butter, vinegar, malt extract, water, nuts and so on.

The present invention provides sugarless bread made using the dough composition for sugarless bread. The sugarless bread may include sugar in an amount of 0.5 g or less relative to 100 g of bread. The sugarless bread is made using the dough composition for sugarless bread without sugar added thereto. In addition to flour, grain ingredients may be included in the sugarless bread, thereby lowering a sugar index and preventing dietary life related diseases from occurring due to the intake of sugar or fructose contained in the conventional bread.

The present invention also provides a process for making sugarless bread made using the dough composition for sugarless bread. The process for making sugarless bread using the dough composition for sugarless bread according to the present invention may prevent fermentation capacity of the dough composition from lowering and can prevent a fermentation time from being prolonged due to non-addition of sugar, and can control the sugar that may be generated while making the bread, thereby providing the sugarless bread having low sugar content while having improved taste and textural quality. In addition, the process for making sugarless bread using the dough composition for sugarless bread according to the present invention may control sugar generation while making bread by adjusting a mixing ratio of flour relative to dough composition used in sponge dough and dough processes.

The process for making sugarless bread using the dough composition for sugarless bread according to the present invention may include sponge dough and dough processes and baking. In more detail, the sponge dough process may include preparing a first dough composition and first fermentation, and the dough process may include preparing a second dough composition and second fermentation.

Sponge Dough Process

(1) Preparing First Dough Composition

In the preparing of the first dough composition, the first dough composition is prepared by mixing ingredients of the first dough composition. The first dough composition may include flour, the flour being included in an amount of less than 80 parts by weight and greater than 50 parts by weight, based on 100 parts by weight of flour of a second dough composition to be described later. If the content of the flour is less than 50 parts by weight, the product quality of bread may be deteriorated, and if the content of the flour is greater than 80 parts by weight, sugar content of the bread may increase, making it difficult to attain the sugarless bread with low sugar content of 0.5g/100g or less. In addition, the first dough composition may include 0.1 to 1.1 by weight of an improver and 0.5 to 0.8 parts by weight of yeast, based on 100 parts by weight of flour of the second dough composition.

(2) First Fermentation

In the first fermentation, the first dough composition prepared in the preparing of the first dough composition is fermented to prepare a first fermentation product. The first fermentation may be performed at a temperature of 3° C. to 10° C. for 10 to 16 hours.

Dough Process

(1) Preparing Second Dough Composition

In the preparing of the second dough composition, the second dough composition is prepared by mixing the first fermentation product and ingredients of the second dough composition. The second dough composition is a final dough composition for sugarless bread according to the present invention and is prepared by mixing the remaining ingredients of the dough composition for sugarless bread, except for the ingredients of the first dough composition with the first fermentation product.

(2) Second Fermentation

In the second fermentation, the second dough composition is fermented to prepare the second fermentation product. The fermenting may be performed at a temperature of 32° C. to 40° C. and a relative humidity of 80 to 85% for 80 to 110 minutes.

Baking Process

In the baking process, the second fermentation product is heated at an oven and an electric heater to prepare sugarless bread. The same process and temperature conditions as those of the conventional baking process may be employed, but aspects of the present invention are not particularly limited. The process according to the present invention may further include cooling the sugarless bread produced after the baking.

The present invention is better understood by the following examples, which are not intended to be limiting in any way.

### Examples 1-13

The process for making sugarless bread according to the present invention was carried out by a sponge dough process.

1) Mixing (Sponge Dough Process) and First Fermentation

Ingredients proposed in Table 1 were put into a mixer (in the trade name of SK101S MIXER, Japan) to be driven at stage 1 for 2 minutes and at stage 3 for one minute for making a dough, which is then mixed until the final temperature became 24° C., followed by first fermenting in a fermentation device maintained at 6° C. for 12 hours.

2) Mixing (Dough Process) and Second Fermentation

Among the ingredients proposed in Table 1, flour, an improver, a grain composition, high-sugar yeast, salt and distilled water were put into a mixer for making a dough composition at stage 1 for 2 minutes, adding the fermentation product resulting from the sponge dough process to the mixer and mixing the mixture at stage 1 for 2 minutes and at stage 3 for 3 minutes. Next, butter was added and the dough composition was made at stage 1 for 3 minutes and at stage 3 for 3 minutes, followed by adding walnuts to the mixer and mixing the mixture at stage 1 for 30 seconds. The mixing was performed until the final temperature of the dough composition became 27° C. After making the dough composition, the resultant dough composition was panning, followed by second fermentation at a temperature of 38° C. and a relative humidity of 85% for 80 to 110 minutes.

3) Baking and Cooling

The dough resulting after the second fermentation was baked in a deck oven with 210° C. of upper flames and 250° C. of lower flames for 35 to 38 minutes, and then pulled out from the oven, followed by cooling the baked bread at room temperature until the inner temperature of the bread became 32° C. .

### Comparative Example 1

The sugarless bread was made in the same manner as in Example 1, except that amounts of ingredients proposed of comparative example 1 in Table 1 were used.

### Experimental Example

Sugar content analysis of bread made in Examples and Comparative Example (Korean Food Standards Codex, chap. 10. General test method, 1.1.4.1.4 Qualitative and Quantitative Methods of sugar by instrumental analysis)

The sugar content was analyzed by instrumental analysis using qualitative and quantitative methods according to the Korean Food Standards Codex. For sugar content analysis, baked and cooled samples of sugarless bread were homogenized, homogenized test samples were accurately weighed by 5 g and put into a 50 mL centrifuge, followed by dispersing in 25 mL petroleum ether. The resultant product was centrifuged at 2,000 rpm for about 10 minutes, and the petroleum ether was carefully removed so as not to remove solid matter. This procedure was repeatedly performed to completely evaporate the petroleum ether using nitrogen. Here, in cases of samples confirmed as being fat-free, a de-fatting process was omitted.

To the defatted samples were added 25 mL distilled water or 50% ethanol solution, thereby identifying weights of the samples. The resultant samples were put into a 85° C. tank, and the temperature of the tank was elevated for 25 minutes to extract sugar, followed by cooling at room temperature and adding an extraction solvent to gain a weight of the first extraction solvent (distilled water or 50% ethanol 25 ml). The resultant product was filtered using a 0.45 μm nylon membrane filter to be used as a test solution. Here, in a case where the test solution is turbid, the test solution was filtered by centrifuging at 2,000 rpm for 10 minutes. Next, the centrifuged test solution was analyzed by liquid chromatography using acetonitrile and distilled water in a weight ratio of 80:20 (w/w) with a flow rate of 1.0 mL/min. In the liquid chromatography, a μ-Bondapak carbohydrate column having a length of 300 mm and an internal diameter of 4 mm was used and a refractive index (RI) detector was used. Quantitative testing was carried out to obtain a calibration curve with widths and heights of peaks obtained by injecting 10 μL of each of the test solution and standard solution. Sugar concentrations (μg/mL) contained in the test solution were obtained and sugar content in the test sample (mg/100 g) was calculated using the following equation. Here, the concentration range of the calibration curve of the standard solution was adjusted to satisfy a linear property for each of the sugar concentrations.

Sugar content (mg/100 g)=[S×(a×b)/Test sample amount (g)]×(100/1000)
S: Sugar content in test solution (μg/mL)
a: Total volume of test solution (mL)
b: Multiples of dilution

TABLE 1

| | | | | | | | | | | | | | | | Comp. |
|---|---|---|---|---|---|---|---|---|---|---|---|---|---|---|---|
| | | Example | | | | | | | | | | | | | Exam. |
| Process | Ingredient | 1 | 2 | 3 | 4 | 5 | 6 | 7 | 8 | 9 | 10 | 11 | 12 | 13 | 1 |
| Sponge | Flour | 70 | 70 | 70 | 70 | 70 | 70 | 70 | 70 | 100 | 80 | 70 | 60 | 50 | 70 |
| dough | | | | | | | | | | | | | | | |
| | Improver | 0.45 | 0.45 | 0.45 | 0.45 | 0.45 | 0.45 | 0.45 | 0.45 | 0.45 | 0.45 | 0.45 | 0.45 | 0.45 | 0.45 |
| | Yeast | 0.7 | 0.7 | 0.7 | 0.7 | 0.7 | 0.7 | 0.7 | 0.7 | 0.7 | 0.7 | 0.7 | 0.7 | 0.7 | 0.7 |
| | Water | 42 | 42 | 42 | 42 | 42 | 42 | 42 | 42 | 71 | 47 | 42 | 36 | 28 | 42 |
| Dough | Flour | 30 | 30 | 30 | 30 | 30 | 30 | 30 | 30 | 0 | 20 | 30 | 40 | 50 | 30 |
| | Improver | 0.65 | 0.65 | 0.65 | 0.65 | 0.65 | 0.65 | 0.65 | 0.65 | 0.65 | 0.65 | 0.65 | 0.65 | 0.65 | 0.75 |
| | Salt | 2.0 | 2.0 | 2.0 | 2.0 | 2.0 | 2.0 | 2.0 | 2.0 | 2.0 | 2.0 | 2.0 | 2.0 | 2.0 | 2.0 |
| | Yeast | 1.3 | 1.3 | 1.3 | 1.3 | 1.3 | 1.3 | 1.3 | 1.3 | 1.3 | 1.3 | 1.3 | 1.3 | 1.3 | 1.3 |
| | Butter | 10 | 10 | 10 | 10 | 10 | 10 | 10 | 10 | 10 | 10 | 10 | 10 | 10 | 10 |
| | Vinegar | 1 | 1 | 1 | 1 | 1 | 1 | 1 | 1 | 1 | 1 | 1 | 1 | 1 | 1 |
| | Malt | 1 | 1 | 1 | 1 | 1 | 1 | 1 | 1 | 1 | 1 | 1 | 1 | 1 | 1 |
| | extract | | | | | | | | | | | | | | |
| | Water | 29 | 29 | 29 | 29 | 29 | 29 | 29 | 29 | 0 | 24 | 29 | 35 | 43 | 29 |
| | Walnut | 5 | 5 | 5 | 5 | 5 | 5 | 5 | 5 | 5 | 5 | 5 | 5 | 5 | 5 |
| | Grain | 15 | 20 | 25 | 30 | 35 | 40 | 45 | 50 | 25 | 25 | 25 | 25 | 25 | 25 |
| | Composition | | | | | | | | | | | | | | |

| | | | | | | | | | | | | | | |
|---|---|---|---|---|---|---|---|---|---|---|---|---|---|---|
| Sugar content | 0.44 | 0.41 | 0.23 | 0.21 | 0.25 | 0.34 | 0.32 | 0.3 | 0.79 | 0.58 | 0.28 | 0.39 | 0.50 | 0.78 |
| (g/100 g) | | | | | | | | | | | | | | |

As confirmed from Table 1, the sugarless bread according to the present invention contained low level sugar, that is, 0.5 g/100 g or less. In Example 10 in which 80 parts by weight of flour was contained in the sponge dough process, based on 100 parts by weight of the entire flour of the dough composition the sugar content of the sugarless bread exceeded 0.5 g/100 g. In Example 9 in which 100 parts by weight of flour was injected in the sponge dough process using a straight method, without separating the injection of flour into a sponge dough process and a dough process, the sugar content of the sugarless bread exceeded 0.5 g/100 g. By contrast, in Comparative Example 1 in which 1.2 parts by weight of an improver was contained, it was confirmed that the sugar content of the sugarless bread exceeded 0.5 g/100 g.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined by the appended claims.

What is claimed is:

1. A dough composition for sugarless bread, comprising:
(A) 0.1 to 1.1 parts by weight of an improver;
(B) 15 to 50 parts by weight of a grain mixture; and
(C) 1.0 to 2.5 parts by weight of yeast, based on 100 parts by weight of flour of the dough composition,
wherein the grain mixture includes one or more selected from the group consisting of alpha soybean powder, eggs, soy protein isolate and gluten.

2. The dough composition for sugarless bread of claim 1, wherein the improver (A) includes one or more selected from the group consisting of hemicellulase, vitamin C, seaweed calcium, emulsifier, and glucoseoxidase.

3. The dough composition for sugarless bread of claim 1, wherein the grain mixture includes one or more selected from the group consisting of rice powder, barley powder and brown rice powder.

4. The dough composition for sugarless bread of claim 1, wherein based on 100 parts by weight of flour of the dough composition, the grain mixture comprises: 3 to 15 parts by weight of barley powder; 3 to 15 parts by weight of brown rice powder; 0 to 5 parts by weight of alpha soybean powder; 10 to 40 parts by weight of eggs; 0 to 5 parts by weight of soy protein isolate; and 0 to 3 parts by weight of gluten.

5. Sugarless bread made from the dough composition for sugarless bread of any one of claims 1 to 4.

6. The sugarless bread of claim 5, wherein sugar content in the sugarless bread is contained in an amount of 5 g or less per 100 g of the sugarless bread.

7. A processes for making sugarless bread, the process comprising:
preparing a first dough composition to mix ingredients of the first dough composition;
first fermentation of preparing a first fermentation product by fermenting the first dough composition; preparing a second dough composition to mix the first fermentation product and ingredients of the second dough composition; and
second fermentation of preparing a second fermentation product by fermenting the second dough composition; and
baking the second fermentation product,
wherein the first dough composition comprises:
(A) 0.1 to 1.1 parts by weight of an improver; and
(B) 0.5 to 0.8 parts by weight of yeast, based on 100 parts by weight of flour of the second dough composition,
the second dough composition comprises:
(A) 0.1 to 1.1 parts by weight of an improver;
(B) 15 to 50 parts by weight of a grain mixture; and
(C) 1.0 to 2.5 parts by weight of yeast, based on 100 parts by weight of flour, and
the grain mixture includes one or more selected from the group consisting of alpha soybean powder, eggs, soy protein isolate and gluten.

8. The process of claim 7, wherein the first dough composition is in an amount of less than 80 parts by weight, based on 100 parts by weight of flour of the second dough composition, and includes 50 parts by weight or greater of flour.

9. The process of claim 7, wherein the improver (A) includes one or more selected from the group consisting of hemicellulase, vitamin C, seaweed calcium, emulsifier, and glucoseoxidase.

10. The process of claim 7, wherein the grain mixture includes one or more selected from the group consisting of rice powder, barley powder and brown rice powder.

11. The process of claim 10, wherein. based on 100 parts by weight of flour of the second dough composition, the grain mixture comprises: 3 to 15 parts by weight of barley powder; 3 to 15 parts by weight of brown rice powder; 0 to 5 parts by weight of alpha soybean powder; 10 to 40 parts by weight of eggs; 0 to 5 parts by weight of soy protein isolate; and 0 to 3 parts by weight of gluten.

12. The process of claim 7, wherein the first fermentation is performed at a temperature of 3° C. to 10° C. for 10 to 16 hours.

13. The process of claim 7, wherein the second fermentation is performed at a temperature of 32° C. to 40° C. and a relative humidity of 80% to 85% for 90 to 110 hours.
